(19) United States
(12) Patent Application Publication
(10) Pub. No.: US 2021/0171066 A1
(43) Pub. Date: Jun. 10, 2021

(54) METHOD FOR CONTROLLING AN AUTONOMOUSLY DRIVING PASSENGER TRANSPORT VEHICLE

(71) Applicant: ROBERT BOSCH GMBH, Stuttgart (DE)

(72) Inventors: Markus KOEHLER, Ditzingen (DE); Dennis NIENHUESER, Weil Der Stadt (DE); Holger Andreas BANZHAF, Laichingen (DE); Joachim BOERGER, Stuttgart (DE); Markus SCHUETZ, Tuebingen (DE); Markus MAZZOLA, Stuttgart (DE); Miriam SCHREIBER, Weil Der Stadt (DE); Nandor NAGY, Renningen (DE); Steffen KNOOP, Hohenwettersbach (DE); Steffen WAELDELE, Renningen (DE); Thomas SCHAMM, Karlsruhe (DE)

(73) Assignee: Robert Bosch GmbH, Stuttgart (DE)

(21) Appl. No.: 17/046,442

(22) PCT Filed: May 24, 2019
(86) PCT No.: PCT/EP2019/063456

§ 371 Date: Oct. 9, 2020

(30) Foreign Application Priority Data
Jun. 20, 2018 (DE) 10 2018 210 026.8

(51) Int. Cl. B60W 60/00; B60W 40/09; B60W 30/08

(52) U.S. Cl. CPC B60W 60/0016; B60W 2040/0881; B60W 30/08; B60W 40/09

(57) ABSTRACT

A method and to a device for controlling an autonomously driving passenger transport vehicle. The driving behavior of the passenger transport vehicle is adapted to an ascertained passenger situation. When the vehicle is empty, driving may be rather aggressive, whereas in the case of there being occupants in the vehicle, more attention may be paid to their comfort and safety.

The present invention relates to a method for controlling an autonomously driving passenger transport vehicle in which a driving behavior of the passenger transport vehicle is adapted to an ascertained passenger situation, as well as to a corresponding device.

### BACKGROUND INFORMATION

So-called robotic taxis/shuttles will become part of public mass transit in the near future. In particular, at the beginning of the introduction, passengers will not be able to assess, or will have difficulty assessing, the driving behavior of the automatically driving shuttle. Various physical conditions of the passengers additionally result in a different perception of the driving mode of such shuttles, as does the selection of a seat or standing spot. As a result of the automation of the shuttles, empty trips without a driver or passengers also become possible.

### SUMMARY

A method according to the present invention advantageously enables an optimal driving behavior for the particular situation. According to the present invention, this is made possible by the features described herein. Further embodiments of the present invention are described herein.

In the method according to an example embodiment of the present invention for controlling an autonomously driving passenger transport vehicle, a driving behavior of the passenger transport vehicle is adapted to an ascertained passenger situation.

Autonomously driving passenger transport vehicles are understood to mean, in particular, so-called robotic taxis or robotic shuttles (also robo shuttle or shuttle). Such vehicles are characterized, for example, in that only passenger places are present. In particular, no driver work station is configured, i.e., no steering wheel and no gas pedal are present in the vehicle. The passenger places may be configured as seats or standing spots, for example.

A device, for example in the form of a camera, monitors the passenger compartment of the shuttle during operation. An instantaneously present passenger situation may be ascertained with the aid of an evaluation device. If no passengers are in the shuttle, this is identified, and the shuttle may thus dispense entirely with comfortable driving, and thereby arrive at the destination more quickly or more efficiently. When a passenger enters and selects his or her place, it is identified via the device what needs the passenger possibly has. If multiple passengers are on board, the driving behavior is adapted according to the identified needs of all passengers. The ascertained needs are interpreted, and corresponding measures are defined, or a suitable driving behavior is selected. One possible measure is, for example, slower smooth driving all the way to stopping of the automated driving vehicle.

The following situations shall be understood as examples: When a passenger has a standing spot, curves are negotiated more slowly and less sharply. In addition, braking and acceleration are more gentle. It is also possible to respond to a standing passenger not holding on. If all passengers have taken seats, driving may take place with slightly more speed. The result is a faster advancement, with the passengers still perceiving it as pleasant and safe.

Such a method may advantageously enable an increased comfort since passengers experience a driving behavior which meets their needs. Such a method furthermore enhances the safety since, e.g. standing people, elderly people, or people in wheelchairs, are accelerated less strongly in the vehicle due to, e.g., gentler accelerations and brake applications, or lower curve speeds, and, e.g., falls or rolling away is/are prevented. Moreover, a faster advancement during empty trips, i.e., trips without passengers, is achieved by such a method. This results in a higher efficiency of the vehicle. An adapted driving behavior of the automated vehicle also increases the acceptance of automated vehicles without a driver since they move in the traffic situation in a way that is pleasant for the passengers. The integration of such a method into an autonomous passenger transport vehicle also results in an option for distinguishing it from other means of transportation which cannot assess their passengers or respond thereto, such as for example subway and light railroad trains.

In one advantageous specific embodiment of the present invention, in the method, a first autonomous driving behavior is implemented in a first passenger situation, in particular, the first autonomous driving behavior being designed in such a way that the comfort and/or the safety of a passenger is/are optimized, and, in a second passenger situation, a second autonomous driving behavior is implemented, in particular, the second autonomous driving behavior being designed in such a way that the speed and/or the efficiency of the advancement of the passenger transport vehicle is/are optimized.

As was already described, the driving behavior of the automated passenger transport vehicle is adaptably designed. This means that different driving modes are defined, or driving styles are executable. The automatic steering maneuvers, acceleration and/or deceleration maneuvers may be configured accordingly differently and be carried out by the vehicle in an automated manner. Depending on which situation is identified, a different driving behavior is set and executed. For example, in a first situation, the presence of a passenger was established. Accordingly, the automated selection of a driving mode takes place, which has a high emphasis on the comfort and safety of the passengers. In this way, a pleasant driving perception as well as an injury risk minimization among the present passengers are made possible. If, in contrast, it is established for example in a second situation that no passenger is present in the vehicle, an automated selection of a driving mode takes place, which has a high emphasis on driving speed and driving dynamics. In this way, the efficiency of the advancement of the empty passenger transport vehicle is made possible.

In one possible embodiment of the present invention, in the method, the ascertainment of the passenger situation takes place taking at least one piece of information with respect to a passenger cabin of the passenger transport vehicle into consideration.

This is understood to mean that the driving behavior of the vehicle is determined taking at least one piece of information with respect to a passenger cabin of the passenger transport vehicle into consideration. This means, data are collected and evaluated to ascertain the appropriate piece of information. The data collection takes place, for example, with the aid of one or multiple camera(s). It is also possible to use 3D cameras in the process. The data evaluation takes place with the aid of a processing unit or a control unit. The data collection as well as the evaluation advantageously take place in an automated manner. Based on the ascertained pieces of information, the setting of the suitable driving mode is carried out.

In one preferred embodiment of the present invention, in the method, the ascertainment of the passenger situation takes into consideration whether at least one passenger is present in the passenger cabin.

This is understood to mean that it is checked whether a passenger is present in the vehicle. If this is the case, a corresponding driving mode may be set, for example, to optimize the safety and comfort of the occupant.

In one alternative refinement of the present invention, in the method, the ascertainment of the passenger situation takes into consideration in what position a passenger is situated.

This is understood to mean that the position of a passenger situated in the vehicle is checked, and to use this piece of information during the establishment of the suitable driving behavior. For example, it may be identified in the process whether the passenger has taken a seat on a vehicle seat or is standing. Furthermore, it may be identified whether the passenger is holding on. This allows conclusions to be drawn on the stability of the occupant. This may advantageously be taken into consideration in the selection of the suitable driving behavior. In addition to the instantaneous position, it is also possible to ascertain position changes, for example unsteady standing all the way to falling down. Such position changes may, for example, also be correlated in combination with the driving maneuvers carried out, for example a fall with the preceding brake application. Furthermore, it may be ascertained, in particular due to position changes, whether the instantaneous driving behavior is suitable for the existing passenger situation or should be changed.

In one advantageous embodiment of the present invention, in the method, the ascertainment of the passenger situation takes into consideration the physical state of a passenger.

This is understood to mean that the physical condition of a passenger in the vehicle is checked, and to use this piece of information during the establishment of the suitable driving behavior. For example, the approximate age of the occupant may be ascertained in the process. Furthermore, it may be ascertained whether the passenger uses a walking aid or also whether he or she is in a wheelchair. Such pieces of information also allow conclusions to be drawn on the stability of the passenger. This may advantageously be taken into consideration in the selection of the suitable driving behavior.

In one possible example embodiment of the present invention, in the method, the ascertainment of the passenger situation takes into consideration the mental state of a passenger.

This is understood to mean that the emotional state of a passenger in the vehicle is checked, and to use this piece of information during the establishment of the suitable driving behavior. These pieces of information may advantageously be taken into consideration in the selection of the suitable driving behavior. For example, different emotions may be identified in the process, for example fear. This information may, for example, be ascertained by an evaluation of the facial features or the behavior of the passenger. For example, it is also possible to use emotions of the passengers with respect to the traffic situation (sharp intake of breath, screaming, also falling asleep, impatient harrumphing) during the trip to carry out an adaptation with respect to an enhanced comfort and safety perception or with respect to shorter travel times.

In one preferred refinement of the present invention, in the method, the ascertainment of the passenger situation takes all passengers into consideration, in particular, the physical and/or positional and/or mental state of each individual passenger.

In one alternative specific embodiment of the present invention, in the method, the ascertainment of the passenger situation takes place in an automated manner.

As was described above, the information ascertainment for the estimation of the passenger situation takes place with the aid of an image recording via a passenger compartment camera and a corresponding data evaluation. In the process, both the data collection and the evaluation advantageously take place in an automated manner. An estimation of a present passenger situation takes place in the process. Based on the ascertained pieces of information, the selection and execution of the suitable driving mode are carried out.

In particular, an identification of the occupant needs with respect to the driving behavior may also take place prior to restarting. It may be checked whether occupants are in the correct sitting position. If this is not the case, no starting takes place. It may also be checked whether people have fallen due to, e.g., a prior brake application. In this case, no starting takes place initially either. If, e.g., a fall of an occupant (e.g., in the case of elderly people) has occurred, it is also possible to carry out measures such as stopping or slower smooth driving.

This method may, for example, be implemented in software or hardware or in a mixed form made up of software and hardware, for example in a control unit.

The present invention furthermore provides a device which is designed to carry out, activate or implement the steps of one variant of a method described here in appropriate units. The object underlying the present invention may also be achieved quickly and efficiently by this embodiment variant of the present invention in the form of a device.

A device may presently be understood to mean an electrical device which processes sensor signals and outputs control and/or data signals as a function thereof. The device may include an interface which may be designed as hardware and/or software. A device shall, for example, be understood to be an appropriately configured control unit for passenger situation identification. It may also be understood as a control unit for the automated vehicle control, or, as an alternative, an accordingly configured passenger compartment camera.

In addition, in accordance with the present invention, a computer program product or computer program is advantageous, having program code which may be stored on a machine-readable carrier or memory medium such as a semiconductor memory, a hard disk memory or an optical memory, and which is used to carry out, implement and/or activate the steps of the method according to one of the specific embodiments described above, in particular if the program product or program is executed on a computer or a device.

### BRIEF DESCRIPTION OF THE DRAWINGS

It shall be noted that the features listed individually in the description may be combined with one another in an arbitrary, technically meaningful manner and show further embodiments of the present invention. Further features and the expediency of the present invention may be derived from the description of exemplary embodiments below based on the accompanying figures.

FIG. 1 shows a schematic representation of a passenger situation in a passenger transport vehicle.

FIG. 2 shows a representation of the method steps of one specific embodiment of the present invention.

### DETAILED DESCRIPTION OF EXAMPLE EMBODIMENTS

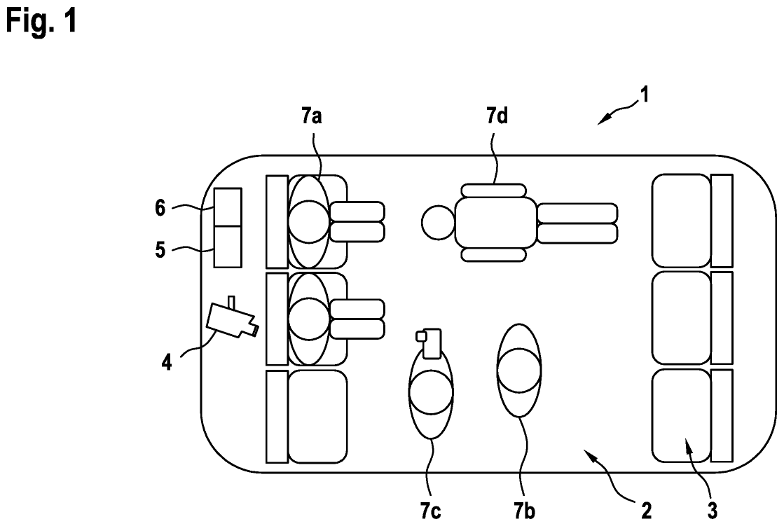

FIG. 1 shows a schematic representation of a passenger situation in an autonomously driving passenger transport vehicle. Shown is passenger cabin 2 in an autonomously driving passenger transport vehicle 1. It has six passenger seats 3. Two of passenger seats 3 are occupied by sitting passengers 7a. Furthermore, a standing passenger 7b is present in passenger cabin 2, as well as a standing passenger 7c who is holding on to a holding device. In addition, a passenger 7d is lying on the floor after a tumble. Passenger cabin 2 is monitored with the aid of a passenger compartment camera 4. The data of passenger compartment camera 4 are evaluated with the aid of a control unit 5 for ascertaining the passenger situation. The driving behavior of passenger transport vehicle 1 is adapted with the aid of a control unit 6 based on the ascertained passenger situation. In the identified present situation, the vehicle is stopped, for example. In addition, continued driving may initially be suppressed due to the identified situation of the fallen passenger. It is also possible that, thereafter, the driving behavior, in the form of a learning system, is further adapted, for example by slower and smoother automated driving, as long as the previously fallen passenger is on board.

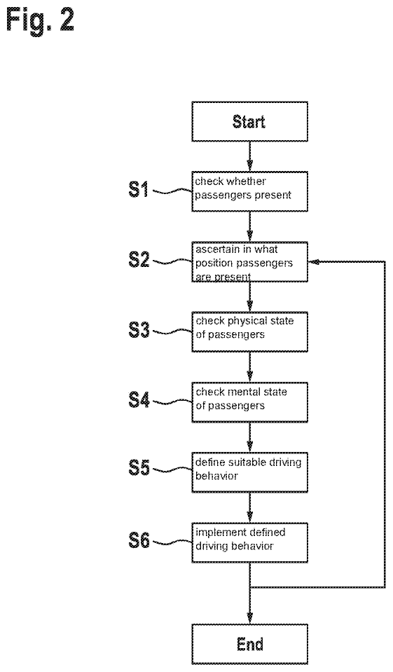

FIG. 2 shows a representation of the method steps of one specific embodiment of the present invention. After the start of the method, a check is carried out in a first step S1 as to whether passengers are present in the passenger cabin. If this is the case, it is ascertained in a second step S2 in what position the passengers are situated. In the process, it is ascertained whether all passengers are sitting on passenger seats or whether, at least some, are standing. If standing passengers are identified, it may be taken into consideration whether they are standing in a stable position, for example leaning against the vehicle wall. It is also checked whether standing passengers are holding on to a holding device. In a further step S3, the physical state of the passengers is checked. This may be carried out both for the sitting and, in particular, the standing passengers. In the process, for example, physical deficits and frailty may be ascertained, for example old age, the use of a walker or wheelchair. In a further step S4, the mental state of the passengers is checked. In the process, feelings and emotions of the passengers are to be ascertained. In the process, in particular the behavior of the passengers is monitored and analyzed. From the behavior of the passengers (for example sharp intake of breath, screaming, falling asleep, impatient harrumphing), feelings and emotions of the passengers with respect to the traffic situation and the instantaneous driving behavior may be derived. In a next step S5, a suitable driving behavior is defined, which meets the present needs. This defined driving behavior is accordingly implemented in step S6 during the autonomous driving operation. The method steps may be continuously repeated to define the respective suitable driving strategy during the entire autonomous driving operation. The method steps may be arranged and executed both sequentially and parallel to one another. For example, a simultaneous execution of steps S2, S3 and S4 is possible. The method is ended, for example, when the planned target position of the passenger transport vehicle has been reached.

1-12. (canceled)

13. A method for controlling an autonomously driving passenger transport vehicle, the method comprising the following steps:
ascertaining a passenger situation; and
adapting a driving behavior of the passenger transport vehicle to the ascertained passenger situation.

14. The method as recited in claim 13, wherein:
in a first passenger situation, a first autonomous driving behavior is implemented, the first autonomous driving behavior being configured in such a way that a comfort and/or the safety of a passenger is optimized; and
in a second passenger situation, a second autonomous driving behavior is implemented, the second autonomous driving behavior being configured in such a way that a speed and/or efficiency of the advancement of the passenger transport vehicle is optimized.

15. The method as recited in claim 13, wherein the ascertainment of the passenger situation takes place taking at least one piece of information with respect to a passenger cabin of the passenger transport vehicle into consideration.

16. The method as recited in claim 13, wherein the ascertainment of the passenger situation takes into consideration whether at least one passenger is present in the passenger cabin.

17. The method as recited in claim 13, wherein the ascertainment of the passenger situation takes into consideration in what position a passenger is situated.

18. The method as recited in claim 13, wherein the ascertainment of the passenger situation takes into consideration a physical state of a passenger.

19. The method as recited in claim 13, wherein the ascertainment of the passenger situation takes into consideration a mental state of a passenger.

20. The method as recited in claim 13, wherein the ascertainment of the passenger situation takes all passengers into consideration including a physical state and/or a positional state and/or mental state, of each individual passenger.

21. The method as recited in claim 13, wherein the ascertainment of the passenger situation takes place in an automated manner.

22. A device configured to control an autonomously driving passenger transport vehicle, the device configure to:
ascertaining a passenger situation; and
adapt a driving behavior of the passenger transport vehicle to the ascertained passenger situation.

23. A non-transitory machine-readable memory medium on which is stored a computer program for controlling an autonomously driving passenger transport vehicle, the computer program, when executed by a computer, causing the computer to perform the following steps:
ascertaining a passenger situation; and
adapting a driving behavior of the passenger transport vehicle to the ascertained passenger situation.
